(19) United States
(12) Patent Application Publication
(10) Pub. No.: US 2026/0026471 A1
(43) Pub. Date: Jan. 29, 2026

(54) PET GROOMING APPARATUS

(71) Applicant: Allison J. Saunders, Columbia, CT (US)

(72) Inventor: Allison J. Saunders, Columbia, CT (US)

(21) Appl. No.: 19/278,203

(22) Filed: Jul. 23, 2025

Related U.S. Application Data
(60) Provisional application No. 63/674,476, filed on Jul. 23, 2024.

(51) Int. Cl. A01K 13/00

(52) U.S. Cl. CPC A01K 13/00

(57) ABSTRACT

A pet grooming apparatus is disclosed, designed to contain pet fur during grooming sessions, enhancing cleanliness and efficiency in grooming environments. The apparatus comprises a netting that defines a compartment for a portion of the pet, featuring a head hole with an adjustable opening to secure the pet's head having an adjustment chord having a toggle stopper to secure the pet's head. The netting is constructed from a fine mesh material that captures loose fur while allowing airflow, ensuring pet comfort. The apparatus includes a grooming arm for securely positioning the animal, with adjustable supports to accommodate various sizes and breeds. The netting is equipped with an adjustment cord having a toggle stopper to secure the netting to a structure, effectively trapping fur and minimizing cleanup time.

### CROSS-REFERENCE TO RELATED APPLICATIONS

This application claims benefit to Provisional Application No. 63/674,476, filed Jul. 23, 2024, the contents of which are herein incorporated by reference.

### BACKGROUND OF THE INVENTION

### Field of Endeavor

The present disclosure pertains to pet grooming technologies, specifically to apparatuses designed to contain pet fur during grooming to maintain cleanliness and reduce product waste in grooming salons.

### Background of Related Art

In the field of pet grooming, maintaining hygiene and efficiency during animal grooming sessions has become a growing concern. Grooming facilities and professionals are continually confronted with the challenge of managing loose hair that is generated during routine grooming procedures. As the industry evolves, the need for solutions that effectively address hair containment becomes more significant. The focus on both aesthetics and sanitation in groomers' workspaces has spurred efforts to improve methods for controlling stray hair. This context has fueled interest in inventive approaches that contribute to a cleaner, more organized grooming environment.

Many grooming establishments aim to enhance operational efficiency by reducing the disruption and additional work caused by loose animal hair during and after procedures. The objective is to integrate measures that not only maintain the visual appeal of the grooming area but also protect the health and safety of both the animals and the professionals. By streamlining the process with effective hair containment methods, businesses can offer a refined service experience that minimizes clean-up time and improves overall salon functionality, thereby aligning with the high standards expected in today's competitive pet care industry.

A general issue observed in many grooming settings is the difficulty in preventing stray animal hair from dispersing throughout the work area. Conventional methods often fall short in their ability to capture hair effectively, resulting in dispersed debris that requires extensive clean-up afterwards. This situation not only increases labor but also disrupts the workflow in busy grooming salons. The challenge of effectively retaining loose hair during grooming procedures remains a persistent problem, affecting both aesthetics and operational efficiency.

More specific challenges arise when managing hair during procedures that involve high-speed drying or vigorous grooming techniques. In such cases, traditional apparatus and methodologies may only provide limited protection, typically offering partial solutions that focus solely on certain aspects of the grooming process. This creates situations where hair escapes capture, necessitating additional effort from grooming professionals. The shortcomings observed in current techniques underscore the need for a comprehensive and integrated approach to hair containment that can address these challenges without impeding the grooming process.

### SUMMARY OF THE INVENTION

In one embodiment, the disclosure provides a grooming apparatus designed to contain animal fur during grooming sessions. The apparatus comprises a netting that forms a compartment for a first portion of an animal and includes an inner surface, an outer surface, a first opening, and a second opening. A head hole, creating a compartment for a second portion of the animal and having an inner surface, an outer surface, a first opening, and a second opening, is affixed to the netting around the first opening. The apparatus further includes a first adjustment chord positioned at least partially between the inner surface and the outer surface of the head hole near the second opening, together with a first toggle stopper configured to selectively secure the animal within the head hole. Additionally, a second adjustment chord is positioned at least partially between the inner surface and the outer surface of the netting near the second opening, along with a second toggle stopper configured to selectively secure the netting to a structure.

In further embodiments, the apparatus additionally comprises a grooming arm configured to securely position the animal during grooming sessions. The grooming arm includes at least one vertical support and at least one horizontal support, with the vertical support adjustable along a vertical axis and the horizontal support adjustable along a horizontal axis.

In additional embodiments, the netting is implemented as a mesh netting, and the first and second adjustment chords are elastic.

### BRIEF DESCRIPTION OF THE DRAWINGS

FIG. 1 is a schematic diagram illustrating the pet grooming apparatus designed to contain pet fur during grooming;

FIG. 2 is a side elevation view of the pet grooming apparatus, illustrating the netting system for containing pet fur during grooming; and

FIG. 3 is a cross-sectional view of the pet grooming apparatus taken along line 3-3, illustrating the containment of fur within the net during a grooming process.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

In the field of pet grooming, maintaining a clean and efficient workspace presents a significant challenge. Grooming professionals often encounter the issue of loose pet hair dispersing throughout the salon during grooming sessions, particularly when using high-velocity dryers. Stray hair not only creates a mess but also demands additional time and effort for cleanup, disrupting the workflow and reducing overall efficiency. The presence of loose hair can also pose health and safety concerns for both the animals and the groomers, as it may lead to respiratory issues or allergic reactions.

Existing solutions in the market primarily focus on protecting the groomer from loose hair, such as face shields or netting hats. However, these methods do not address the broader issue of containing hair within the grooming area itself. As a result, hair continues to spread across the salon, necessitating extensive cleanup efforts. Moreover, these conventional methods often fail to provide comprehensive protection for the animal, leaving the pet exposed to potential discomfort or stress during the grooming process.

The present disclosure offers a novel approach to addressing these challenges by introducing a pet grooming apparatus designed to effectively contain pet fur during grooming sessions. This approach provides a comprehensive solution that not only protects the groomer but also ensures the cleanliness and safety of the grooming environment. By covering the animal with a specially designed net, the apparatus captures loose hair, preventing the hair from dispersing throughout the salon. This innovative method streamlines the grooming process, reduces cleanup time, and enhances the overall functionality of grooming facilities.

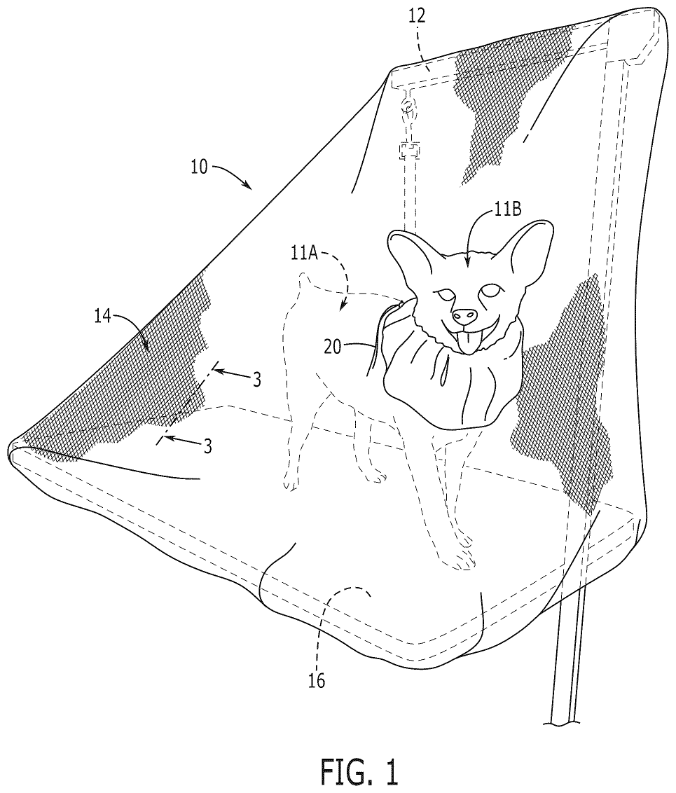

FIG. 1 shows a pet grooming apparatus 10 in use, illustrating the components and their interaction during a grooming session. The apparatus 10 is designed to contain pet fur effectively, thereby maintaining cleanliness in the grooming environment. Pet grooming apparatus 10 can include a plurality of components, such as a grooming arm 12, and netting 14.

Grooming arm 12 is designed to facilitate the grooming process by securely holding the pet in place and providing a structure to support netting 14. The grooming arm 12 is adjustable, allowing for customization to accommodate various sizes and breeds of animals, ensuring both safety and comfort during grooming sessions. The grooming arm 12 is equipped with a loop or clamp mechanism that gently but firmly secures the pet, preventing movement that could lead to injury or inefficiency in grooming. Additionally, the arm is constructed from durable materials to withstand the rigors of frequent use in professional grooming environments, while the ergonomic design minimizes strain on the groomer, enhancing overall workflow and productivity.

In embodiments, grooming arm 12 has at least one vertical support having a first end and a second end, and at least one horizontal support having a first end and a second end. In embodiments, the at least one vertical support is adjustable along at least a vertical access, and the at least one horizontal support is adjustable along at least a horizontal access, allowing for customization to accommodate various sizes and breeds of animals, ensuring both safety and comfort during grooming sessions. Additionally, grooming arm 12 can be a component of a larger grooming assemble be being affixed to grooming table 16 using one or more clamps, clasps, clips, or other known means of attachment, to affix the at least one vertical support arm to grooming table 16. Alternatively, grooming arm can be affixed one or more additional structures, or could be freestanding.

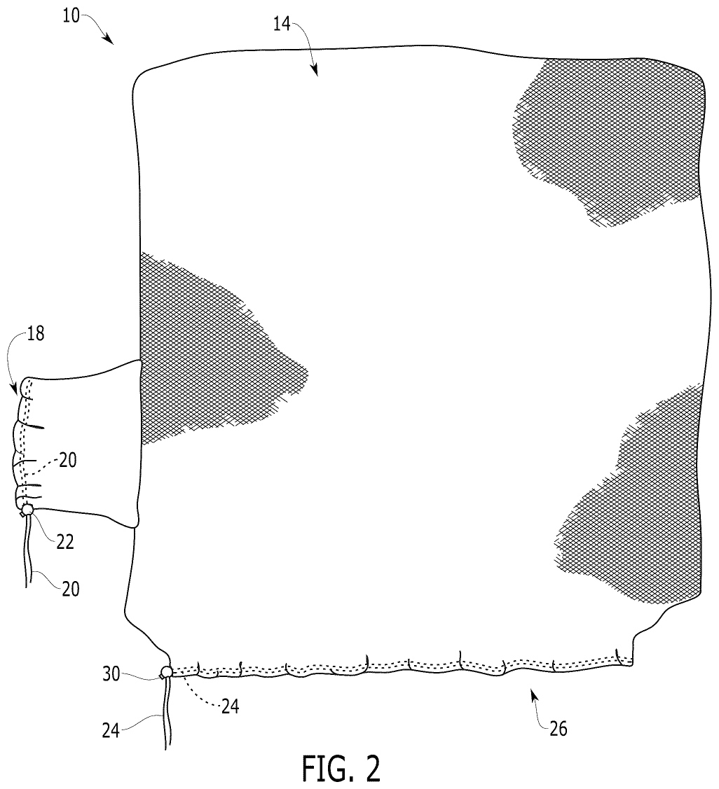

Netting 14 is designed to effectively contain pet fur during grooming sessions. The netting is constructed from a durable, fine mesh material that is both lightweight and resilient, ensuring the netting can withstand the rigors of repeated use in professional grooming environments. The mesh is specifically engineered to capture loose fur while allowing air to circulate, preventing overheating and ensuring the comfort of the pet during the grooming process. The netting is strategically sized to cover the entire body of the animal 11A, with an adjustable opening that accommodates the pet's head 11B, ensuring a secure fit that prevents fur from escaping. This design not only aids in maintaining a clean grooming area by trapping fur within the net but also enhances the safety and efficiency of the grooming process by minimizing the need for extensive cleanup. In embodiments, netting 14 can be installed over grooming arm 12 such that a portion, or the entirety of grooming arm 12 is disposed within netting 14. Once disposed over grooming arm 12, netting 14 can be affixed to grooming table 16, described further with respect to FIG. 2.

Overall, the pet grooming apparatus 10 is designed to enhance the grooming experience by containing loose fur, protecting the grooming environment, and ensuring the comfort and safety of the pet. The integration of the grooming arm 12, netting 14, grooming table 16, and adjustment cord 20 demonstrates a comprehensive approach to addressing the challenges faced in professional pet grooming settings.

FIG. 2 shows a side elevation view of the pet grooming apparatus 10, which is designed to contain pet fur during grooming sessions. The apparatus 10 features netting 14, which serves as the main component for capturing loose fur. The netting 14 is constructed from a fine mesh material that is both durable and lightweight, allowing the netting to withstand repeated use in professional grooming environments. The mesh is engineered to capture fur while permitting airflow 30, ensuring the pet remains comfortable and does not overheat during the grooming process.

The netting 14 is equipped with a head hole 18, which is strategically positioned to allow the pet's head to pass through comfortably. The head hole 18 is adjustable, featuring an adjustment cord 20 and a toggle stopper 22. The adjustment cord can be tightened or loosened using the toggle stopper, providing a secure fit around the pet's neck and preventing fur from escaping through the opening. This design ensures that the pet remains comfortable while effectively containing fur within the netting 14.

At the lower end of the netting 14, there is a lower adjustment cord 24, which is used to secure the open end of the netting 26 around the grooming table 16 or other support structures. The lower adjustment cord 24 can be tightened to close the open end of the netting 26, effectively trapping fur within the enclosure. This feature plays an important role in maintaining a clean grooming environment, as the design prevents fur from dispersing throughout the salon. In alternative embodiments, one or more elastic, or stretchable, fabrics can be provided in addition to, or in place of, lower adjustment cord 24 and are used to secure the open end of netting 26 to the grooming table 16 or other support structures, similar to placing a fitted sheet one a mattress.

The combination of the netting 14, head hole 18, adjustment cord 20, toggle stopper 22, lower adjustment cord 24, and open end of the netting 26 work together to provide a comprehensive solution for fur containment, enhancing the efficiency and cleanliness of the grooming process.

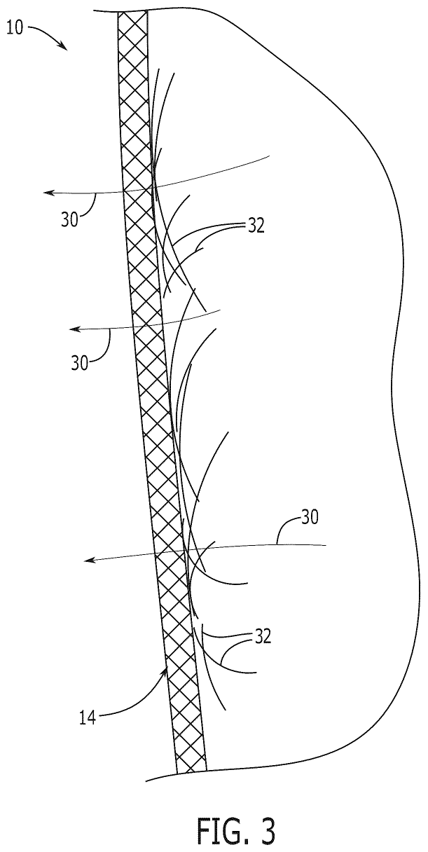

FIG. 3 shows the pet grooming apparatus 10 in operation, specifically illustrating the interaction between airflow 30 and netting 14 to effectively trap hair 32 during a grooming session. The apparatus 10 is designed to enhance the grooming process by capturing loose fur, thereby maintaining cleanliness within the grooming environment.

Airflow 30 plays a significant role in the operation of the apparatus 10. During grooming, high-velocity air is directed towards the pet, dislodging loose fur. The management of airflow 30 is strategic to ensure that the fur 32 is directed into the netting 14, where the fur becomes trapped. This design not only aids in maintaining a clean grooming area by trapping fur within the net 14 but also enhances the safety and efficiency of the grooming process by minimizing the need for extensive cleanup.

A user utilizes dog grooming apparatus 10 by installing the apparatus 10 over grooming arm 12, or other animal restraint device. In embodiments, a pet can be placed inside netting 14 through open end of netting 26 and secured to grooming arm 12, or other animal restraint device, prior to securing open end of netting 26 to grooming table 16, or, alternatively the pet can be secured to grooming arm 12, or other animal restraint device, prior to any installation of apparatus 10.

Once the pet is in place, the open end of netting 26 can be secured to the grooming table 16 by the placing open end of netting 26 over the grooming table 16 and tightening the lower adjustment chord 24 using the lower toggle stopper 28. Alternatively, an elastic fabric is used in place of, or in addition to, the lower adjustment chord 24, which self-secures to the grooming table 16.

Once apparatus 10 is securely installed, the pet's head 11B is maneuvered into the head hole 18. The head hole 18 is secured around the neck of the pet's head 11B by tightening the adjustment chord 20 using the toggle stopper 22.

Once the pet's head 11B is secured, high velocity air 30 is blown over the apparatus to dislodge fur, debris, etc., which is trapped by netting 14. The trapped hair 32 within the netting 14 demonstrates the effectiveness of the apparatus 10 in containing loose fur. This containment plays a significant role in reducing the disruption and additional work caused by stray hair during and after grooming procedures. By streamlining the process with effective hair containment methods, grooming facilities can offer a refined service experience that minimizes clean-up time and enhances overall salon functionality.

It should be understood, of course, that the foregoing relates to exemplary embodiments of the invention and that modifications may be made without departing from the spirit and scope of the invention as set forth in the following claims.

What is claimed is:

1. A grooming apparatus for containing animal fur during grooming sessions, the apparatus comprising:
a netting defining a compartment for a first portion of an animal having at least an inner surface, an outer surface, a first opening, and a second opening;
a head hole defining a compartment for a second portion of the animal having an inner surface, an outer surface, a first opening, and a second opening, wherein the first opening of the head hole is affixed to the netting around the first opening of the netting;
a first adjustment chord installed at least partially between the inner surface of the head hole and the outer surface of the head hole proximate to the second opening of the head hole;
a first toggle stopper affixed to the first adjustment chord and configured to selectively secure the animal in the head hole;
a second adjustment chord installed at least partially between the inner surface of the netting and the outer surface of the netting proximate to the second opening of the netting;
a second toggle stopper affixed to the second adjustment chord and configured to selectively secure the netting in a structure.

2. The grooming apparatus of claim 1, further comprising:
a grooming arm configured to securely position the animal during grooming, the grooming arm including at least one vertical support and at least one horizontal support.

3. The grooming apparatus of claim 1, wherein the netting is a mesh netting.

4. The dog grooming apparatus of claim 2, wherein the at least one vertical support being adjustable along at least a vertical axis, and the at least one horizontal support being adjustable along at least horizontal axis.

5. The dog grooming apparatus of claim 1, wherein the first adjustment chord is elastic.

6. The dog grooming apparatus of claim 1, wherein the second adjustment chord is elastic.
